(19) United States
(12) Patent Application Publication
(10) Pub. No.: US 2005/0270436 A1
(43) Pub. Date: Dec. 8, 2005

(54) Display apparatus

(75) Inventors: Yukiharu Miyamura, Shizuoka (JP); Koichi Kaneko, Shizuoka (JP)

Correspondence Address: SUGHRUE MION, PLLC, 2100 PENNSYLVANIA AVENUE, N.W., SUITE 800, WASHINGTON, DC, 20037, US

(73) Assignee: PIONEER CORPORATION

(21) Appl. No.: 11/133,468

(22) Filed: May 20, 2005

(30) Foreign Application Priority Data
May 20, 2004 (JP) P2004-150938
Sep. 1, 2004 (JP) P2004-254324

(51) Int. Cl. G02F 1/1333

(52) U.S. Cl. 349/58

(57) ABSTRACT

A display apparatus includes: a display panel; a chassis attached to a back face of the display panel; a first sheet having first thermal conductivity which is interposed in a first region between the chassis and the display panel; and a second sheet having second thermal conductivity higher than the first thermal conductivity the second sheet interposed in a second region between the chassis and the display panel.

### BACKGROUND OF THE INVENTION

1. Field of the Invention

The present invention relates to a display apparatus as a flat type display apparatus.

2. Background Art

Recently, there have been developed various kinds of flat type display apparatus in which a thin display panel in a shape of flat plate such as a plasma display panel, a liquid crystal display panel, and an organic electro luminescence panel is employed.

FIG. 1 shows, as an example, a general structure of the display apparatus in which the above described display panel is incorporated.

As shown in the drawing, a case body containing a display panel 1 includes a front frame 6 having an opening in which a front cover formed of glass or the like is arranged, and a rear cover 7.

The display panel 1 is held by attaching it to a front face of a chassis 3 formed of aluminum alloy or the like, by means of a double-faced adhesive tape 5. There are attached to a back face of the chassis 3, a plurality of circuit blocks (circuit boards) 2 such as a scan circuit board carrying a drive circuit for actuating the display panel 1 to display, and a drive circuit board carrying an electric power circuit for supplying power to the aforesaid drive circuit.

FIG. 2 shows a connecting structure between the display panel 1 and the chassis 3 in such a flat type display apparatus in the prior art.

As shown in the drawing, the display panel 1 includes a front glass board 1A and a rear glass board 1B which are bonded to each other interposing a discharging space 1C. A circuit board 2 for driving this display panel 1 is mounted on this display panel 1, by way of the chassis 3.

The aforesaid chassis 3 is a plate-like member formed of metal, such as aluminum alloy, which has good thermal conductivity. The display panel 1 and the circuit board 2 are electrically connected by means of a flexible cable 4, and further, the display panel 1 is fixed to the chassis 3 by means of the double-faced adhesive tape 5 which has been attached to an outer face of the rear glass board 1B of the display panel 1 (a back face of the display panel 1).

As described above, an art of employing the double-faced adhesive tape 5 in the flat type display apparatus, as means for fixing the chassis 3 and the display panel 1, has been known (See JP-A-5-11183U, for example).

### SUMMARY OF THE INVENTION

As described above, the chassis 3 and the display panel 1 are rigidly bonded to each other, by interposing the double-faced adhesive tape 5 between them, and the bonded state is shown in a schematic view of FIG. 3.

However, there has been probability that such distortion or warp as shown in a schematic view of FIG. 4 may occur in the display panel 1 and the chassis 3 during manufacturing process.

When the display panel 1 and the chassis 3 are bonded to each other by means of the double-faced adhesive tape 5 in a state where the distortion or warp has occurred in the display panel 1 and the chassis 3 (in the state as shown in FIG. 4), a gap 8 will be created between the display panel 1 and the chassis 3.

This gap 8 will be a cause for drop of the display panel 1 from the chassis 3, and a cause for hindering heat emitted from the display panel 1 from being uniformly radiated. For this reason, sufficient thickness has been given to the double-faced adhesive tape 5 so that the gap created by the distortion or warp can be compensated.

In case where the thickness of this double-faced adhesive tape 5 has increased, thermal conductivity of the double-faced adhesive tape 5 becomes deteriorated. For this reason, in case where the double-faced adhesive tape 5 having an increased thickness has been employed, it would be difficult to secure sufficient heat radiation performance of the display panel 1.

Under the circumstances, in order to secure the heat radiation performance of the display panel 1, substance having high thermal conductivity (such as silicone) has been contained in the double-faced adhesive tape 5.

However, in case where the substance having the high thermal conductivity (such as silicone) has been contained in the double-faced adhesive tape 5, cost for the double-faced adhesive tape 5 has increased, and in addition, weight of the double-faced adhesive tape 5 has increased, thus hindering weight reduction of the product.

Additionally, on occasion of applying the double-faced adhesive tape 5, air has happened to enter into the gap between the display panel 1 and the chassis 3 thereby to deteriorate tight contact between them, which would hinder heat radiation from the display panel 1.

Moreover, the display panel 1 must be sometimes removed from the chassis 3 for the purpose of repairing the display apparatus, and it has been known that the double-faced adhesive tape 5 is relatively difficult to be removed. Additionally, because the double-faced adhesive tape 5 has been bonded to a substantially entire area between the display panel 1 and the chassis 3, it has an extensive contact area.

For these reasons, a relatively long time has been taken to remove the display panel 1 from the chassis 3, which has been a drawback in enhancing serviceability in repairing work.

As the problems that the invention is to solve, there are those problems which have occurred in the above described prior art, for example, a problem that it is difficult to secure tight contact between the panel and the chassis, a problem that it is difficult to maintain such holding strength that the panel may not drop from the chassis, a problem that it is difficult to secure heat radiation performance from the panel, a problem that it is difficult to achieve cost cutting as well as weight reduction, and a problem that it is difficult to enhance serviceability in repairing work.

The invention provides a display apparatus, including: a display panel; a chassis attached to a back face of the display panel; a first sheet having first thermal conductivity which is interposed in a first region between the chassis and the display panel; and a second sheet having second thermal conductivity higher than the first thermal conductivity the second sheet interposed in a second region between the chassis and the display panel.

### BRIEF DESCRIPTION OF THE DRAWINGS

The present invention may be more readily described with reference to the accompanying drawings:

FIG. 1 is an exploded perspective view showing a conventional display apparatus.

FIG. 2 is a sectional view showing the conventional display apparatus.

FIG. 3 is a schematic view (a perspective view) showing a panel and a chassis in a state bonded to each other, in the conventional display apparatus.

FIG. 4 is a schematic view (a perspective view) showing a gap created between the panel and the chassis in the conventional display apparatus.

FIG. 5 is an exploded perspective view showing a display apparatus according to a first embodiment of the invention.

FIG. 6 is an exploded perspective view showing a connecting structure between a panel and a chassis in the display apparatus according to the first embodiment of the invention.

FIG. 7 is an exploded perspective view showing a connecting structure between a panel and a chassis in a display apparatus according to a second embodiment of the invention.

FIG. 8 is an exploded perspective view showing a connecting structure between a panel and a chassis in a modification of the second embodiment of the invention.

FIG. 9 is an exploded perspective view showing a connecting structure between a panel and a chassis in a display apparatus according to a third embodiment of the invention.

FIG. 10 is an exploded perspective view showing a connecting structure between a panel and a chassis in a display apparatus according to a fourth embodiment of the invention.

FIG. 11 is an exploded perspective view showing a connecting structure between a panel and a chassis in a display apparatus according to a fifth embodiment of the invention.

FIG. 12 is an exploded perspective view showing a connecting structure between a panel and a chassis in a display apparatus according to a sixth embodiment of the invention.

FIG. 13 is an exploded perspective view showing a connecting structure between a panel and a chassis in a display apparatus according to a seventh embodiment of the invention.

FIG. 14 is an exploded perspective view showing a connecting structure between a panel and a chassis in a display apparatus according to an eighth embodiment of the invention.

FIG. 15 is an exploded perspective view showing a connecting structure between a panel and a chassis in a display apparatus according to a ninth embodiment of the invention.

FIG. 16 is an exploded perspective view showing a connecting structure between a panel and a chassis in a display apparatus according to a tenth embodiment of the invention.

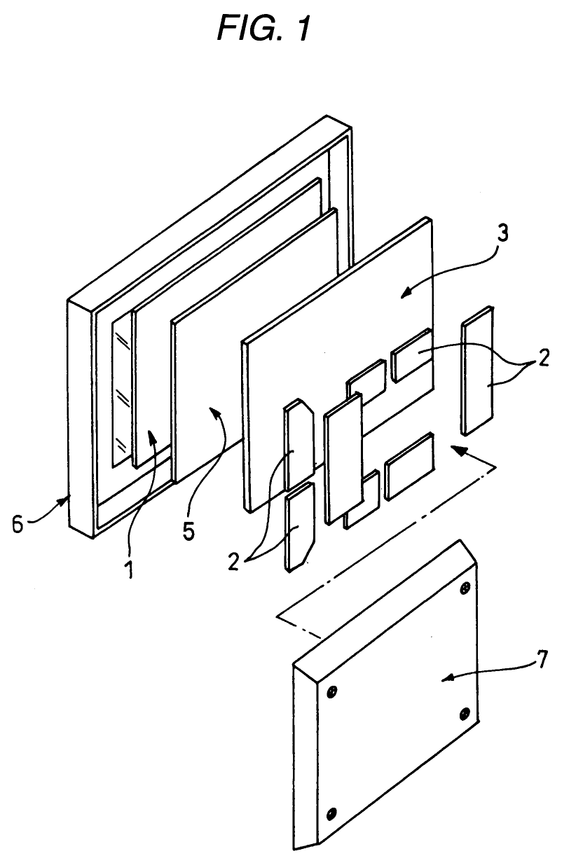

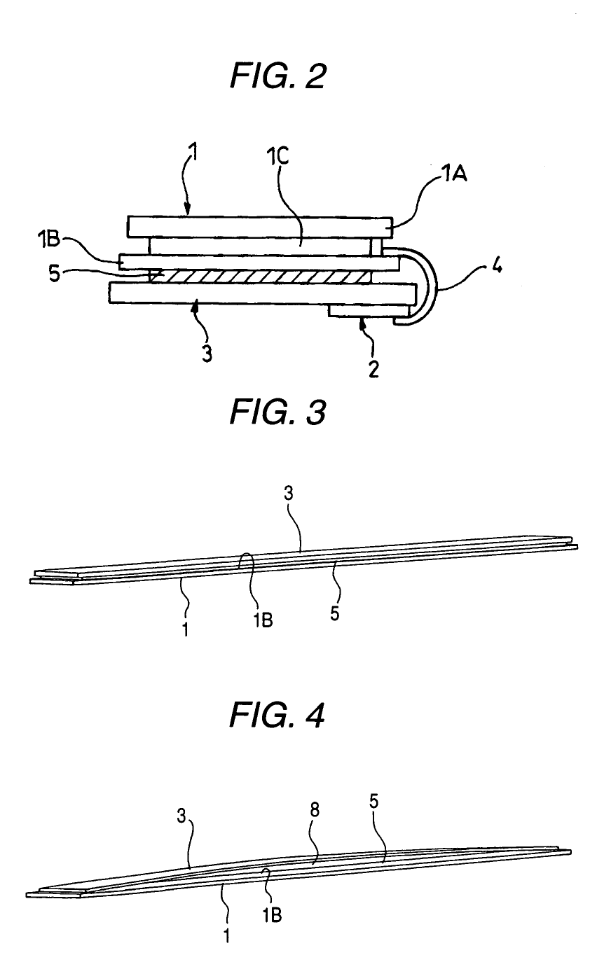

### DETAILED DESCRIPTION OF THE PREFERRED EMBODIMENTS

Now, several embodiments of the display apparatus according to the invention will be described in detail, referring to the drawings.

### First Embodiment

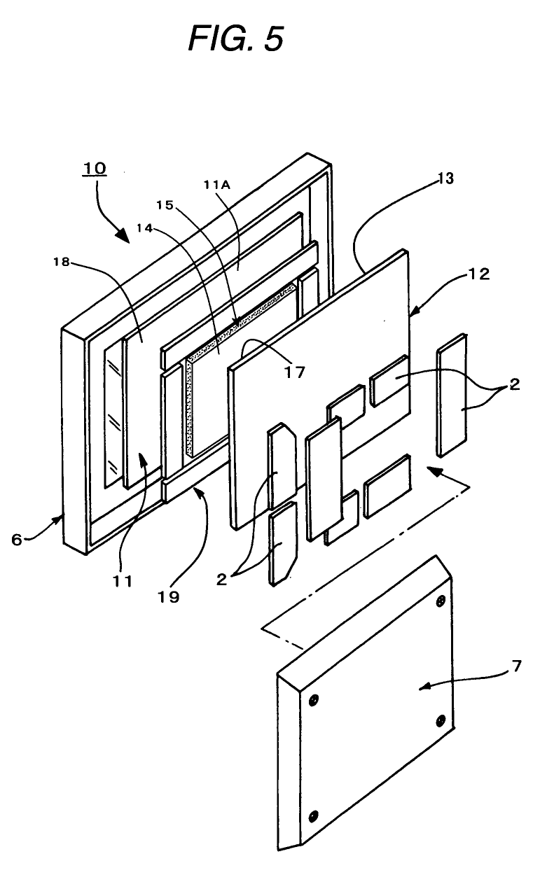

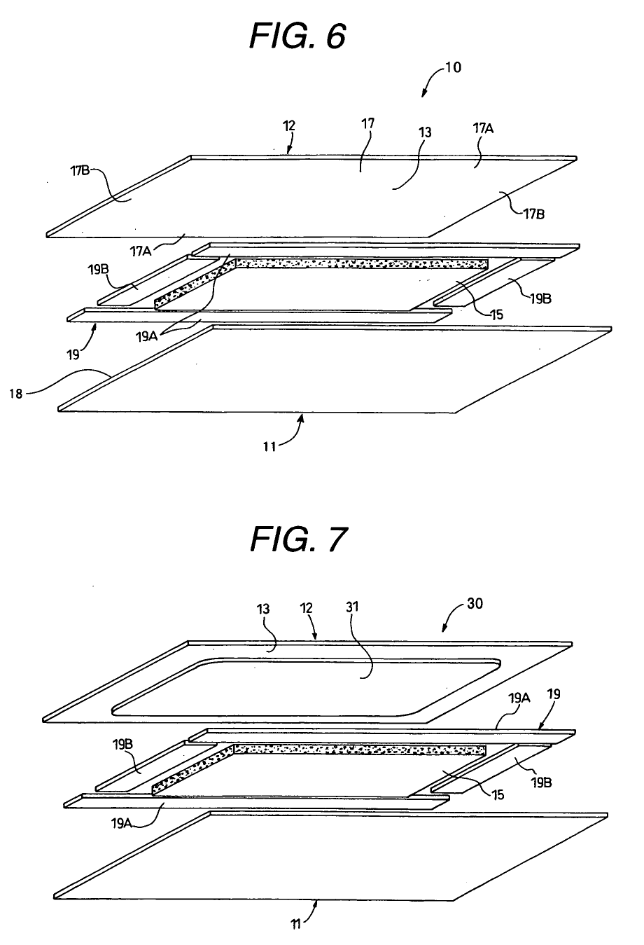

FIG. 5 is a perspective view showing a general structure of the display apparatus in a first embodiment according to the invention, and FIG. 6 is an exploded perspective view showing a connecting structure between a display panel and a chassis in FIG. 5.

As shown in FIG. 5, a case body which contains a display panel 11 in the display apparatus 10 includes a front frame 6 having an opening in which a front cover formed of glass or the like is arranged, and a rear cover 7.

The display panel 11 is held by bonding it to a peripheral part 17 (See FIG. 6 too) of a panel mounting face 13 of a chassis 12 which is formed of aluminum alloy or the like, by means of a double-faced adhesive tape 19. There are attached to a back face of the chassis 3, a plurality of circuit blocks (circuit boards) 2 such as a scan circuit board carrying a drive circuit for driving the display panel 1 to display, and a drive circuit board carrying an electric power circuit for supplying power to the aforesaid drive circuit. The chassis 12 is a plate-like member formed of metal, such as aluminum alloy, having good thermal conductivity. The display panel 1 and the circuit blocks (circuit boards) 2 are electrically connected by means of a flexible cable or the like (not shown).

This display apparatus 10 includes the display panel 11, and the chassis 12 attached to a back face 11A of the display panel 11. A foamed silicone sheet (a second sheet having second thermal conductivity which is higher than first thermal conductivity) 15 having flexibility is interposed in a center part 14 between the chassis 12 and the display panel 11, and at the same time, the double-faced adhesive tape (a first sheet having the first thermal conductivity) 19 is interposed in the peripheral parts 17, 18 between the chassis 12 and the display panel 11.

The foamed silicone sheet 15 is a heat radiation sheet having flexibility which is formed by foaming substance having high thermal conductivity.

This foamed silicone sheet 15 has a thickness larger than a gap which is created when the chassis 12 and the display panel 11 are bonded to each other. Accordingly, the display panel 11 is brought into tight contact with the chassis 12, without interposing an air layer between the display panel 11 and the chassis 12.

The foamed silicone sheet 15 can be made of a small amount of material, because the material has been foamed. Therefore, the weight and cost can be reduced, and it is possible to provide a light-weight product at a low cost.

The double-faced adhesive tape 19 is interposed in the peripheral parts 17, 18 between the chassis 12 and the display panel 11.

The double-faced adhesive tape 19 includes a pair of double-faced adhesive tape pieces l9A, and a pair of double-faced adhesive tape pieces 19B, which have been formed into a frame body in a substantially rectangular shape.

A pair of the double-faced adhesive tape pieces 19A are the tape pieces provided along a pair of side areas 17A in a longitudinal direction in the peripheral part 17 of the chassis 12 which is formed in a rectangular shape.

A pair of the double-faced adhesive tape pieces 19B are the tape pieces provided along a pair of side areas 17B in a lateral direction in the peripheral part 17 of the chassis 12 which is formed in a rectangular shape.

One of adhesive faces of this double-faced adhesive tape 19 is bonded to the peripheral part 18 of the display panel 11, and at the same time, the other adhesive face of the double-faced adhesive tape 19 is bonded to the peripheral part 17 of the chassis 12.

In this manner, the peripheral part 18 of the display panel 11 and the peripheral part 17 of the chassis 12 are bonded to each other by means of the double-faced adhesive tape 19.

As the results, it has become possible to rigidly bond the display panel 11 to the chassis 12, and bonding strength can be maintained so as to prevent the display panel 11 from dropping from the chassis 12 with vibration or so.

Moreover, an amount of the double-faced adhesive tape 19 to be used can be decreased, because the double-faced adhesive tape 19 is interposed only along the respective peripheral parts 17, 18 between the chassis 12 and the display panel 11.

Additionally, the double-faced adhesive tape 19 is an ordinary double-faced adhesive tape which can be easily obtained.

As described above, it is possible to reduce the cost for the display apparatus 10, by employing the ordinary double-faced adhesive tape 19 which can be easily obtained, and by decreasing the amount of the double-faced adhesive tape 19 to be used.

As fully described herein above, in the display apparatus 10 according to this embodiment which includes the display panel 11, and the chassis 12 attached to the back face 11A of the display panel 11, the foamed silicone sheet 15 having flexibility is interposed in the center part 14 between the chassis 12 and the display panel 11, and at the same time, the double-faced adhesive tape 19 is interposed in the peripheral parts 17, 18 between the chassis 12 and the display panel 11.

As the results, it has become possible to bond the display panel 11 and the chassis 12 to each other, without creating a gap (in other words, an air layer) between the members 11, 12, and tight contact between the display panel 11 and the chassis 12 can be secured.

By securing the tight contact between the display panel 11 and the chassis 12, heat radiation performance from the display panel 11 to the chassis 12 can be sufficiently secured.

Moreover, because the foamed silicone sheet 15 is interposed between the display panel 11 and the chassis 12, it is not necessary for the double-faced adhesive tape to contain the substance having high thermal conductivity (such as silicone), and to interpose this double-faced adhesive tape over the substantially entire area between the display panel 11 and the chassis 12, as in the prior art.

In case where the substance having high thermal conductivity (such as silicone) has been contained in the double-faced adhesive tape, the cost for the double-faced adhesive tape has increased and the weight of the double-faced adhesive tape has also increased. However, according to this embodiment, the above substance need not be contained, and thus, the cost cutting and weight reduction can be achieved.

Further, on occasion of removing the display panel 11 from the chassis 12 for repairing purpose, it has become possible to easily remove the display panel 11 from the chassis 12 without taking a long time, and to achieve enhancement of serviceability.

Then, second and third embodiments will be described referring to FIG. 7 to FIG. 9. It is to be noted that in the second and third embodiments, same or similar members as in the first embodiment will be denoted with the same reference numerals, and description of the members will be omitted.

### Second Embodiment

In a display apparatus 30 according to the second embodiment, the chassis 12 has a convexo-plane part 31 in a center part of the panel mounting face 13 thereof, and the foamed silicone sheet 15 is interposed between this convexo-plane part 31 and the display panel 11.

By forming the convexo-plane part 31 in the center part of the panel mounting face 13, the gap between the display panel 11 and the chassis 12 can be made smaller. As the results, thickness of the foamed silicone sheet 15 can be reduced.

According to the display apparatus 30 in the second embodiment, substantially same effects as the display apparatus 10 in the first embodiment can be obtained.

Additionally, according to the display apparatus 30 in the second embodiment, the thickness of the foamed silicone sheet 15 can be reduced, because the convexo-plane part 31 is formed in the center part of the panel mounting face 13. As the results, it is possible to decrease an amount of the foamed silicone sheet 15 to be used, and to further achieve the cost cutting.

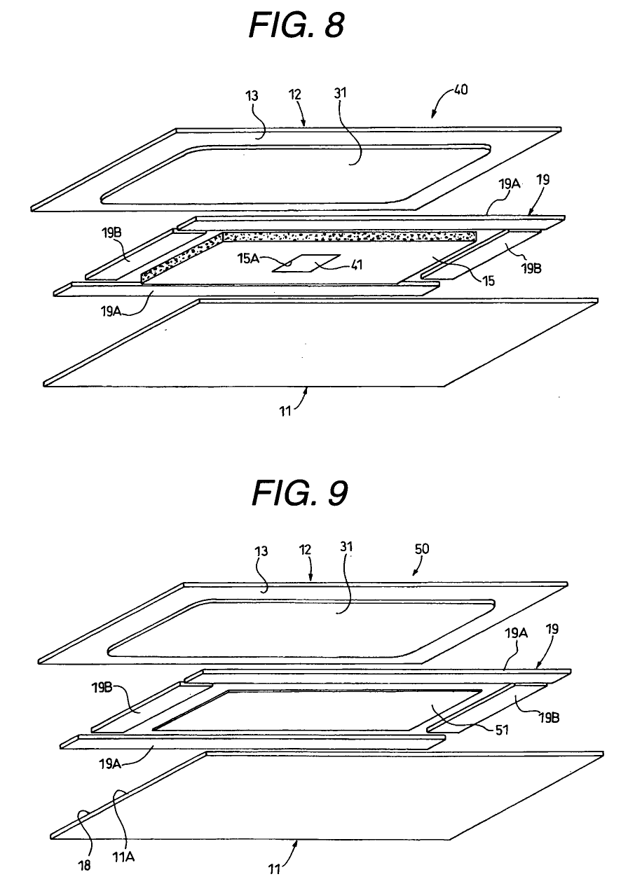

A modification of the second embodiment will be shown in FIG. 8.

A display apparatus 40 in the modification has a panel side recess 15A which is formed in a center part of the foamed silicone sheet 15 on its face opposed to the display panel 11, and a double-faced adhesive tape 41 is provided in this panel side recess 15A. On the other hand, a chassis side recess (not shown) is formed on the other face opposed to the convexo-plane part 31 of the chassis 12, and a double-faced adhesive tape 41 (not shown) is provided in this chassis side recess. In this manner, the double-faced adhesive tapes 41 are partially interposed between the foamed silicone sheet 15 in the panel side recess 15A and the display panel 11, and between the foamed silicone sheet 15 in the chassis side recess and the chassis 12.

As the results, it is possible to bring more favorably the foamed silicone sheet 15 into tight contact with both the display panel 11 and the chassis 12.

Additionally, because the double-faced adhesive tape in the chassis side recess is bonded to the convexo-plane part 31 of the chassis 12, and at the same time, the double-faced adhesive tape 41 in the panel side recess 15A is bonded to the display panel 11, it is possible to more reliably prevent the display panel 11 from dropping from the chassis 12 with vibration or so.

The display apparatus 40 in the modification has been described referring to the case in which the double-faced adhesive tapes 41 are respectively interposed between the foamed silicone sheet 15 and the display panel 11, and between the foamed silicone sheet 15 and the convexo-plane part 31 of the chassis 12. However, the invention is not limited to the case, but it is also possible to interpose the double-faced adhesive tape 41 only between the foamed silicone sheet 15 and the display panel 11. Further, it is also possible to interpose the double-faced adhesive tape 41 only between the foamed silicone sheet 15 and the convexo-plane part 31 of the chassis 12.

Moreover, as another modification, it is also possible to construct the display apparatus in such a manner that the foamed silicone sheet 15 has an opening in a substantially rectangular shape (not shown) in a center part thereof, and the double-faced adhesive tape 41 is provided in this opening, wherein one of the adhesive faces of the double-faced adhesive tape 41 is bonded to the display panel 11, and at the same time, the other adhesive face is bonded to the convexo-plane part 31 of the chassis 12.

By bonding the display panel 11 and the convexo-plane part 31 of the chassis 12 by means of only one double-faced adhesive tape 41, it is possible to more favorably bring the foamed silicone sheet 15 into tight contact with the display panel 11 and the convexo-plane part 31 of the chassis 12.

### Third Embodiment

A display apparatus 50 in the third embodiment includes the display panel 11, and the chassis 12 attached to the back face 11A of the display panel 11. The panel mounting face 13 of the chassis 12 has the convexo-plane part 31 in the center part thereof. A first double-faced adhesive tape (a second sheet having second thermal conductivity which is higher than first thermal conductivity) 51 having a first film thickness is interposed between this convexo-plane part 31 and the display panel 11, and at the same time, a second double-faced adhesive tape (a first sheet having the first thermal conductivity) 19 having a second film thickness which is larger than the first film thickness is interposed between the peripheral part 17 of the chassis 12 except the convexo-plane part 31 and the peripheral part 18 of the display panel 11.

The second double-faced adhesive tape 19 is exactly the same as the double-faced adhesive tape 19 in the first and second embodiments, but has the film thickness which is substantially equal to a sum of a height of the convexo-plane part 31 of the chassis 12 and the film thickness of the first double-faced adhesive tape 51.

Therefore, when the first double-faced adhesive tape 51 has been bonded to the convexo-plane part 31 of the chassis 12 and the display panel 11, the second double-faced adhesive tape 19 can be favorably bonded to the peripheral part 17 of the chassis 12 and the peripheral part 18 of the display panel 11.

In this manner, it has become possible to bond the display panel 11 and the chassis 12 to each other, without creating a gap (in other words, an air layer) between the members 11, 12, and tight contact between the display panel 11 and the chassis 12 can be secured.

Additionally, it has become possible to rigidly bond the display panel 11 to the chassis 12, and to maintain such bonding strength that the display panel 11 can be prevented from dropping from the chassis 12 with vibrations or so.

Briefly speaking, in the display apparatus 50 in the third embodiment, the first double-faced adhesive tape 51 is employed in place of the foamed silicone sheet 15 in the second embodiment as shown in FIG. 7, and other constituents of the display apparatus 50 are the same as those of the display apparatus 30 in the second embodiment.

According to the display apparatus 50 in the third embodiment, substantially the same effects as in the first and second embodiments can be obtained.

Additionally, according to the display apparatus 50 in the third embodiment, cost cutting can be attained, because the foamed silicone sheet 15 which is employed in the first and second embodiments is eliminated.

Further, the first film thickness of the first double-faced adhesive tape 51 can be reduced, because the convexo-plane part 31 is formed in the center part of the panel mounting face 13. By thus reducing the first film thickness of the first double-faced adhesive tape 51, the thermal conductivity can be favorably secured. Therefore, it is unnecessary for the double-faced adhesive tape to contain the substance having high thermal conductivity (such as silicone), as in the prior art.

Additionally, in case where the first double-faced adhesive tape 51 contains the substance having high thermal conductivity (such as silicone), the cost for the first double-faced adhesive tape 51 and the weight thereof will be increased. However, according to this embodiment, the above described substance need not be contained, and so, the cost cutting and weight reduction can be achieved.

In the above described first to third embodiments, description has been made referring to the case in which the peripheral part 17 between the chassis 12 and the display panel 11 is defined as the first region which is provided with the first sheet having the first thermal conductivity (the double-faced adhesive tape 19), and the center part 14 between the chassis 12 and the display panel 11 is defined as the second region which is provided with the second sheet having the second thermal conductivity (the foamed silicone sheet 15, the first double-faced adhesive tape 51). Now, an example in which the center part 14 is defined as the first region, and the peripheral part 17 is defined as the second region will be described in fourth to sixth embodiments.

It is to be noted that in the fourth to sixth embodiments, same or similar members as in the first to third embodiments will be denoted with the same reference numerals, and description of the members will be omitted.

### Fourth Embodiment

FIG. 10 is an exploded perspective view showing a connecting structure between a panel and a chassis of a display apparatus according to a fourth embodiment.

As shown in FIG. 10, a display apparatus 60 in the fourth embodiment includes the display panel 11 and the chassis 12 attached to the back face 11A of the display panel 11. The double-faced adhesive tape 19 is interposed in the center part 14 between the chassis 12 and the display panel 11, and at the same time, the foamed silicone sheet 15 having flexibility is interposed in the peripheral parts 17, 18 between the chassis 12 and the display panel 11.

### Fifth Embodiment

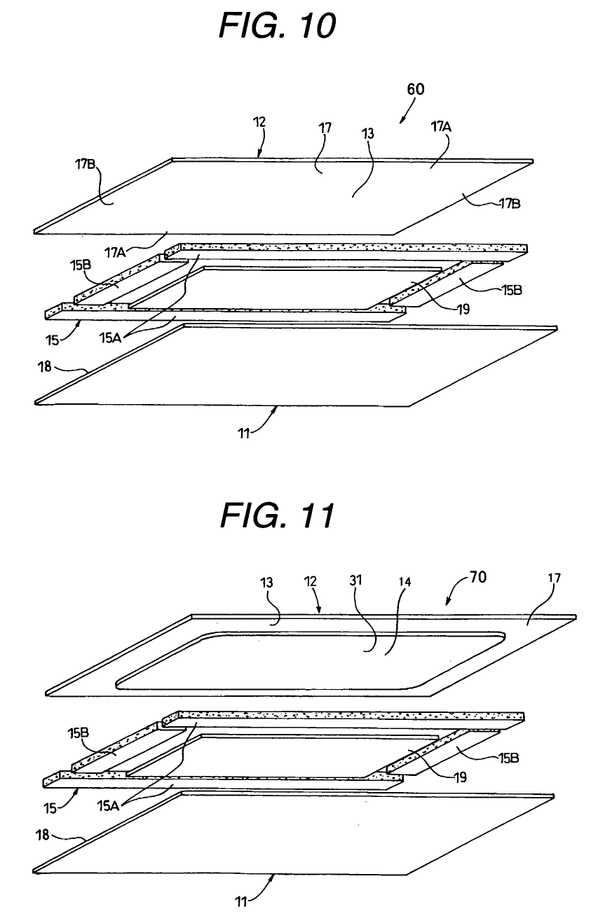

FIG. 11 is an exploded perspective view showing a connecting structure between a panel and a chassis of a display apparatus according to a fifth embodiment.

As shown in FIG. 11, a display apparatus 70 in the fifth embodiment has the convexo-plane part 31 formed on the panel mounting face 13 of the chassis 12 in the center part thereof. The double-faced adhesive tape 19 is interposed between the convexo-plane part 31 and the display panel 11, and at the same time, the foamed silicone sheet 15 having flexibility is interposed in the peripheral parts 17, 18 between the chassis 12 and the display panel 11.

### Sixth Embodiment

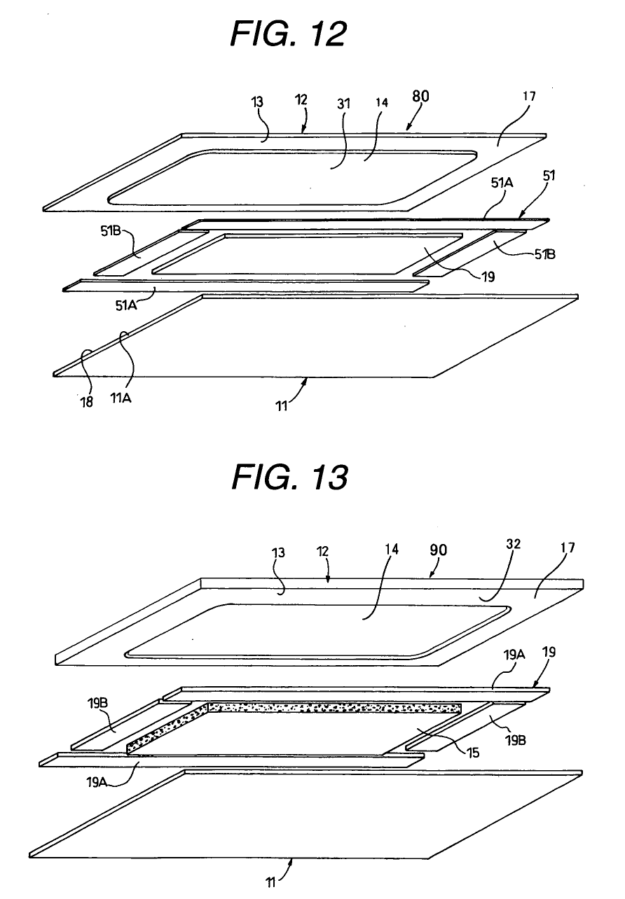

FIG. 12 is an exploded perspective view showing a connecting structure between a panel and a chassis of a display apparatus according to a sixth embodiment.

As shown in FIG. 12, a display apparatus 80 in the sixth embodiment includes the display panel 11 and the chassis 12 attached to the back face 11A of the display panel 11, and the convexo-plane part 31 is formed in the center part 14 of the panel mounting face 13 of the chassis 12. The second double-faced adhesive tape 19 having the second film thickness is interposed between the convexo-plane part 31 and the display panel 11, and at the same time, the first double-faced adhesive tape 51 having the first film thickness which is smaller than the second film thickness is interposed in the peripheral parts 17, 18 between the chassis 12 and the display panel 11.

In the above described second, third, fifth and sixth embodiments, description has been made referring to the case in which the convexo-plane part 31 is formed in the region of the center part 14 between the chassis 12 and the display panel 11. Now, a case in which a convexo-plane part 32 is formed in the region of the peripheral part 17 will be described in seventh to tenth embodiments. It is to be noted that in the seventh to tenth embodiments, same or similar members as in the first to the sixth embodiments will be denoted with the same reference numerals, and description of the members will be omitted.

### Seventh Embodiment

FIG. 13 is an exploded perspective view showing a connecting structure between a panel and a chassis of a display apparatus according to a seventh embodiment.

As shown in FIG. 13, a display apparatus 90 in the seventh embodiment includes the display panel 11 and the chassis 12 attached to the back face 11A of the display panel 11, and the convexo-plane part 32 is formed in the peripheral part 17 of the panel mounting face 13 of the chassis 12. The double-faced adhesive tape 19 is interposed between this convexo-plane part 32 and the display panel 11, and at the same time, the foamed silicone sheet 15 having flexibility is interposed in the center part 14 between the chassis 12 and the display panel 11.

### Eighth Embodiment

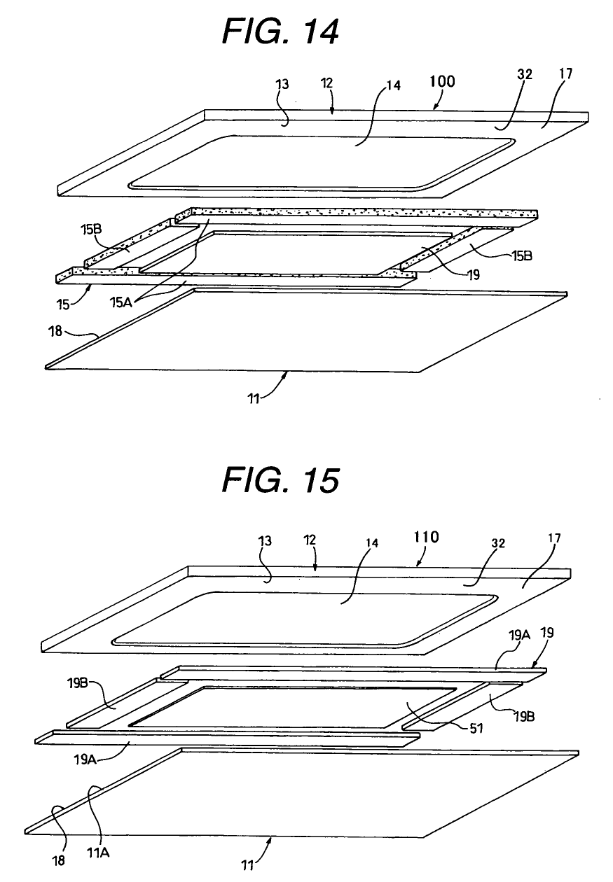

FIG. 14 is an exploded perspective view showing a connecting structure between a panel and a chassis of a display apparatus according to an eighth embodiment.

As shown in FIG. 14, a display apparatus 100 in the eighth embodiment includes the display panel 11 and the chassis 12 attached to the back face 11A of the display panel 11, and the convexo-plane part 32 is formed in the peripheral part 17 of the panel mounting face l3 of the chassis 12. The foamed silicone sheet 15 having flexibility is interposed between this convexo-plane part 32 and the display panel 11, and at the same time, the double-faced adhesive tape 19 is interposed in the center part 14 between the chassis 12 and the display panel 11.

### Ninth Embodiment

FIG. 15 is an exploded perspective view showing a connecting structure between a panel and a chassis of a display apparatus according to a ninth embodiment.

As shown in FIG. 15, a display apparatus 110 in the ninth embodiment includes the display panel 11 and the chassis 12 attached to the back face 11A of the display panel 11, and the convexo-plane part 32 is formed in the peripheral part 17 of the panel mounting face 13 of the chassis 12. The second double-faced adhesive tape 19 having the second film thickness is interposed between this convexo-plane part 32 and the display panel 11, and at the same time, the first double-faced adhesive tape 51 having the first film thickness which is smaller than the second film thickness is interposed in the center part 14 between the chassis 12 and the display panel 11.

### Tenth Embodiment

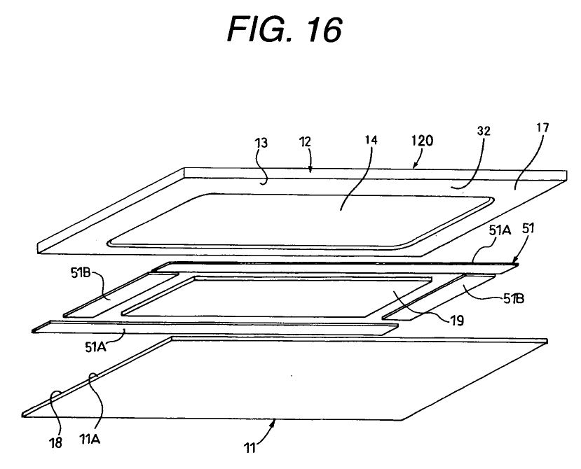

FIG. 16 is an exploded perspective view showing a connecting structure between a panel and a chassis of a display apparatus according to a tenth embodiment.

As shown in FIG. 16 a display apparatus 120 in the tenth embodiment includes the display panel 11 and the chassis 12 attached to the back face 11A of the display panel 11, and the convexo-plane part 32 is formed in the peripheral part 17 of the panel mounting face 13 of the chassis 12. The first double-faced adhesive tape 51 having the first film thickness which is smaller than the second film thickness is interposed between this convexo-plane part 32 and the display panel 11, and at the same time, the second double-faced adhesive tape 19 having the second film thickness is interposed in the center part 14 between the chassis 12 and the display panel 11.

As fully described herein above, the display apparatus in each of the embodiments according to the invention includes the display panel 11 and the chassis 12 attached to the back face of the display panel 11, wherein the first sheet having the first thermal conductivity (the double-faced adhesive tape 19) is interposed in the first region between the chassis 12 and the display panel 11, and at the same time, the second sheet having the second thermal conductivity (the foamed silicone sheet 15, the first double-faced adhesive tape 51) is interposed in the second region between the chassis 12 and the display panel 11.

As the results, it is possible to secure tight contact between the display panel 11 and chassis 12, and to secure heat radiation performance from the display panel 11 while maintaining such holding strength that the display panel 11 may not drop from the chassis 12. Moreover, it is possible to attain cost cutting, weight reduction, and enhancement of serviceability in repairing work.

In the above described embodiments, description has been made referring to the case in which the foamed silicone sheet is employed as the high heat radiation sheet (the second sheet having high thermal conductivity). However, it is possible to employ, in place of the foamed silicone sheet, other high heat radiation sheet, for example, a carbon sheet having remarkably higher thermal conductivity than the foamed silicone sheet, as the high heat radiation sheet (the second sheet having high thermal conductivity). For information, the high heat radiation sheet is expensive, and so, it would be preferable to interpose it between the convexo-plane part of the chassis and the display panel so that the thickness may be reduced, and the amount to be used may be decreased.

1. A display apparatus, comprising:
a display panel;
a chassis attached to a back face of the display panel;
a first sheet having first thermal conductivity which is interposed in a first region between the chassis and the display panel; and
a second sheet having second thermal conductivity higher than the first thermal conductivity the second sheet interposed in a second region between the chassis and the display panel.

2. The display apparatus as claimed in claim 1,
wherein the first region includes a region of a peripheral part between the chassis and the display panel; and
the second region includes a region of a center part between the chassis and the display panel.

3. The display apparatus as claimed in claim 1,
wherein the first region includes a region of a center part between the chassis and the display panel; and
the second region includes a region of a peripheral part between the chassis and the display panel.

4. The display apparatus as claimed in claim 1,
wherein the chassis includes a panel mounting face which has a convexo-plane part formed in one of the first and second regions; and
one of the first and second sheet is interposed between the convexo-plane part and the display panel.

5. The display apparatus as claimed in claim 1,
wherein the first sheet includes an adhesive sheet; and
the second sheet is includes one of a foamed silicone sheet and a carbon sheet.

6. The display apparatus as claimed in claim 5,
wherein the adhesive sheet includes a double-faced adhesive sheet.

7. The display apparatus as claimed in claim 1, further comprising: an adhesive sheet partially interposed between the second sheet and at least one of the display panel and the chassis.

8. The display apparatus as claimed in claim 4,
wherein the sheet interposed between the region of the chassis except the convexo-plane part and the display panel is larger in film thickness than the sheet interposed between the convexo-plane part of the chassis and the display panel.

9. The display apparatus as claimed in claim 8,
wherein the sheet interposed between the region of the chassis except the convexo-plane part and the display panel has a film thickness which is substantially equal to a sum of a height of the convexo-plane part, and the film thickness of the sheet interposed between the convexo-plane part of the chassis and the display panel.
